(19) United States
(12) Patent Application Publication
(10) Pub. No.: US 2006/0117995 A1
(43) Pub. Date: Jun. 8, 2006

(54) Aqueous preparation for coloring surfaces

(75) Inventors: Tatjana Appel, Oberasbach (DE); Gerhard Lugert, Nurnberg (DE); Reiner Appel, Oberasbach (DE)

Correspondence Address: LERNER GREENBERG STEMER LLP, P O BOX 2480, HOLLYWOOD, FL, 33022-2480, US

(73) Assignee: Faber-Castell AG

(21) Appl. No.: 11/294,090

(22) Filed: Dec. 5, 2005

(30) Foreign Application Priority Data
Dec. 3, 2004 (DE) 20 2004 018 813.9

(51) Int. Cl. C09K 3/00; C09D 11/00

(52) U.S. Cl. 106/31.58; 106/31.03

(57) ABSTRACT

An aqueous, in particular cosmetic, preparation for coloring surfaces and the skin, contains a water-soluble dye and has a viscosity of <20 mPa s (20° C., Brookfield). In addition, polyether-1 is present in an amount of from 0.02% to 1%. The polyether-1 makes it possible to prepare colored preparations which can be removed again completely from surfaces with a microporous structure.

### BACKGROUND OF THE INVENTION

### Field of the Invention

The invention relates to an aqueous preparation for coloring surfaces, in particular one for coloring skin. Such liquids are often applied using capillary application devices. The colorants used have to be soluble dyes since pigment dyes would block the capillary system of the application device. The use of pigments is also not possible if transparent colorations are to be produced. For applications in, for example, cosmetics, color applications should on the one hand be permanent, i.e. long-lasting and wipe-resistant, but on the other hand should also be easy to remove again, for example after an unsuccessful attempt at applying makeup, when removing makeup or in the case of non-cosmetic applications when rubbing off writing from whiteboards. It is known that dyes, in the present case thus water-soluble dyes, adhere firmly to many substances, for example with the formation of hydrogen bridges and, on account of their dissolved form, penetrate readily into microporous structures using the solvent as a carrier. For this reason, such color applications can often only be removed primarily from the skin with great effort and in some cases cannot be removed completely even using soap or special cleansing lotions, meaning that a color application has not disappeared completely until days later. Writing on whiteboards, once it has penetrated into their micropores, can often only be inadequately removed, as a result of which the performance capability of the boards deteriorates appreciably.

### SUMMARY OF THE INVENTION

It is an object of the invention to propose aqueous preparations containing soluble dyes for the transparent coloring of surfaces, or for the coloring of surfaces carried out with the help of capillary application devices, in particular skin, with which it is possible to achieve color applications which are long-lasting and wipe-resistant, but can be readily removed again.

The object is achieved by a preparation of the type specified at the beginning containing polyether-1 in an amount of from 0.02% to 1%.

Surprisingly, it has been found that polyether-1 (CAS No. 415696-59-2), which is usually used as a thickener for creams and pastes, and for low-viscosity preparations is not in itself required, and in fact appears almost counterproductive, prevents the above-described disadvantageous effects of dyes, making it possible to prepare colored preparations which can be removed again completely from surfaces with a microporous structure, primarily from the skin, if necessary using soap or customary cleansing solutions. The substance decisive for this, polyether-1 (abbreviated below to PE-1), appears to have a high affinity to the dyes, and to bind these to itself. This prevents the dyes from penetrating into the surface shortly after application, i.e. when the color application is still wet. After the color application has dried off, a type of film in which the dyes are incorporated forms on the surface. The films that form feel soft and pleasant on the skin, which must be attributable, inter alia, to the fact that no tensions of any kind are produced. It is thus possible to achieve high coloring, transparent, permanent and readily removable uniform colorations which are used primarily in cosmetics and which can be applied using capillary application devices. Finally, it was also surprising that color applications with an increased gloss compared with known preparations for comparable purposes could be produced.

The liquids according to the invention can also be used for the colored highlighting and marking of text passages using pens with capillary writing tips.

A guide formulation which is suitable for a large number of cosmetic applications is composed of 0.02%-1% of PE-1, 0.05%-20% of dye, 1%-30% of humectants, 0.1%-20% of additives and water ad 100%.

Additives are understood as meaning, for example, preservatives, wetting agents, further thickeners, further film formers, care agents, aromas, vitamins, possibly also photo-protective filters. The wetting agents enable the viscosity of the preparations to be varied for one and the same content of PE-1.

Humectants which may be present are glycerol, glycols, such as 1,2-propanediol, 1,2-butanediol, 1,3-butanediol, alcohols or sugars. Furthermore, additional solvents such as ethanol can be used.

In the case of writing on so-called whiteboards, color applications could also be removed completely using dry cloths or paper after some time even after the color applications had dried on. Migration of the dye into enamel or plastic surfaces of the boards which arises with other dye formulations was reduced completely or at least significantly compared to customary aqueous dye preparations which contain no polyether-1. A preparation for the purpose under discussion is composed of 0.02%-1% of PE-1, 1% to 20% of dye, 0.1% to 10% of additives and water ad 100%. The additives present are, for example, wetting agents and preservatives.

The preparations according to the invention are prepared using paddle stirrers or dissolvers and suitable tanks. In many cases, a moderate temperature input, i.e. heating to 40-60° C., can favor the dissolution of the ingredients in the aqueous matrix. The viscosity is adjusted to values of <20 mPa s (20° C. Brookfield).

Other features which are considered as characteristic for the invention are set forth in the appended claims.

Although the invention is described herein as embodied in an aqueous preparation for coloring surfaces, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

The preferred embodiments are now presented in the form of specific examples.

### EXAMPLE 1

| Liquid for coloring lips with a viscosity: | | |
|---|---|---|
| 1,3-Butanediol (humectant) | 20.0% | by wt. |
| Euxyl K 300¹⁾ (preservative) | 1.0% | by wt. |
| Tagat S²⁾ (emulsifier) | 3.0% | by wt. |
| Abil B 8843 (surfactant)³⁾ | 1.0% | by wt. |
| Ceramide A 2 (care substance)⁴⁾ | 2.0% | by wt. |
| CI 45410 | 1.5% | by wt. |
| Polyether-1⁵⁾ | 0.4% | by wt. |
| Vanilla aroma (346142)⁶⁾ | 0.5% | by wt. |
| Water | 70.6% | by wt. |
| | 100.0% | by wt. |

All of the percentages are percentages by weight.
Manufacturer details:
¹⁾Schülke & Mayr GmbH, D-22851 Norderstedt
²⁾Degussa AG, Essen
³⁾Degussa AG, Essen
⁴⁾Sederma GmbH, D-41334 Nettetal
⁵⁾Süd-Chemie AG, Munich
⁶⁾Kurt Georgii, D-71043 Böblingen

### EXAMPLE 2

| Brown-colored liquid for eye shadow applications. | | |
|---|---|---|
| Ethanol | 5.0% | by wt. |
| 1,2-Propanediol | 15.0% | by wt. |
| Euxyl K 300 | 1.0% | by wt. |
| Abil B 8851³⁾ | 1.0% | by wt. |
| Polyether-1⁵⁾ | 0.5% | by wt. |
| C.I. 16035 | 1.2% | by wt. |
| C.I. 42090 | 0.08% | by wt. |
| C.I. 19140 | 0.15% | by wt. |
| D-Panthenol (care substance) | 0.20% | by wt. |
| Water | 76.87% | by wt. |
| | 100.0% | by wt. |

All of the percentages are percentages by weight.
Manufacturer details:
¹⁾Schülke & Mayr GmbH, D-22851 Norderstedt
²⁾Degussa AG, Essen
³⁾Degussa AG, Essen
⁴⁾Sederma GmbH, D-41334 Nettetal
⁵⁾Süd-Chemie AG, Munich
⁶⁾Kurt Georgii, D-71043 Böblingen

### EXAMPLE 3

| Gray aqueous whiteboard liquid. | | |
|---|---|---|
| Ethanol | 5.0% | by wt. |
| 1,3-Propanediol | 8.0% | by wt. |
| Euxyl K 300¹⁾ | 1.0% | by wt. |
| Abil B 8851³⁾ | 3.0% | by wt. |
| Sodium dodecylbenzenesulfonate | 0.5% | by wt. |
| (CAS No. 25155-30-0) | | |
| Polyether-1⁵⁾ | 0.4% | by wt. |
| C.I. 16035 | 0.095% | by wt. |
| C.I. 42090 | 0.03% | by wt. |
| Water | 81.975% | by wt. |
| | 100.0% | by wt. |

All of the percentages are percentages by weight.
Manufacturer details:
¹⁾Schülke & Mayr GmbH, D-22851 Norderstedt
²⁾Degussa AG, Essen
³⁾Degussa AG, Essen
⁴⁾Sederma GmbH, D-41334 Nettetal
⁵⁾Süd-Chemie AG, Munich
⁶⁾Kurt Georgii, D-71043 Böblingen

This application claims the priority, under 35 U.S.C. § 119, of German patent application No. 20 2004 018 813.9, filed Dec. 3, 2004; the entire disclosure of the prior application is herewith incorporated by reference.

We claim:

1. An aqueous preparation for coloring surfaces and skin, comprising:
a water-soluble dye;
polyether-1 in an amount of from 0.02% to 1% by wt; and
a viscosity of <20 mPa s (20° C., Brookfield).

2. The preparation according to claim 1, further comprising:

| | |
|---|---|
| polyether-1 | 0.02-1% by wt; |
| dye | 0.05-20% by wt; |
| humectant | 1-30% by wt; |
| additives | 0.1-20% by wt; and |
| water | remainder. |

3. The preparation according to claim 1, further comprising:

| | |
|---|---|
| polyether-1 | 0.02-1% by wt; |
| dye | 1-20% by wt; |
| additives | 0.1-10% by wt; and |
| water | remainder. |

4. The preparation according to claim 2, wherein one of said additives is a surfactant.

5. The preparation according to claim 1, wherein the preparation is a cosmetic.

6. A capillary application device for coloring or writing on surfaces, comprising:
a liquid reservoir filled with a preparation, said preparation containing:
a water-soluble dye;
polyether-1 in an amount of from 0.02% to 1% by wt; and
a viscosity of <20 mPa s (20° C., Brookfield).
